(19) United States
(12) Patent Application Publication
(10) Pub. No.: US 2021/0077928 A1
(43) Pub. Date: Mar. 18, 2021

(54) Side Leakage Prevention and Environmentally-Friendly Filter Element

(71) Applicant: Xiaoping Huang, Zhongshan City (CN)

(72) Inventor: Xiaoping Huang, Zhongshan City (CN)

(21) Appl. No.: 16/857,437

(22) Filed: Apr. 24, 2020

(30) Foreign Application Priority Data
Sep. 16, 2019 (CN) 201910870447.7

(51) Int. Cl. B01D 35/30; B01D 17/12

(52) U.S. Cl. CPC B01D 35/30; B01D 2201/304; B01D 2201/307; B01D 17/12

(57) ABSTRACT

The present invention discloses a side-leakage-proof and environmentally-friendly filter element, which relates to the technical field of filter elements; an inner side-leakage-proof layer is fixedly installed on an inner side wall of the skeleton supporting layer, an upper end of the inner side-leakage-proof layer is provided with a water-entry netting, the water-entry netting is fixedly installed at an upper end of the skeleton supporting layer, an inner upper side of the inner side-leakage-proof layer is filled with the first filter material, an inner lower side of the inner side-leakage-proof layer are filled with the second filter material, the bottom middle part of the inner side-leakage-proof layer is provided with a water outlet slot. The present invention can prevent side leakage of water along the outer wall side before filtering, improve the use efficiency of filter material and have high stability; and the present invention has high strength, is not easy to deform, at the same time realizes energy saving and environmental protection, and the service life thereof can be prolonged.

### TECHNICAL FIELD

The present invention belongs to the technical field of filter elements, and in particular relates to a side-leakage-proof and environmentally-friendly filter element.

### BACKGROUND

The filter element is a professional term with a filtering and purifying function, which is a simple device for purifying the resources of the original fluid and for separating resources, there are mainly gas-liquid separating, solid-liquid separating, exhaust dust filtering, and environmental protection. Now the filter elements are mainly divided into materials: stainless steel filter element, copper filter element, titanium filter element, Hastelloy, plastic filter element and other materials; mainly used in oil filtering, air filtering, water filtering, etc., as well as machinery, electronics, petroleum, chemical, transportation and other fields. The filter element separates solid particles in liquid or gas, or makes different material components fully contact to speed up the reaction, which can protect the normal operation of the equipment or clean the air; when the fluid enters the filter element with a certain size filter screen, the impurities are blocked, and the clean fluid flows out through the filter element. The liquid filter element makes the liquid (including oil, water, etc.) and the contaminated liquid cleaned to the state required for production and life, that is, to make the liquid reach a certain degree of cleanliness.

The existing filter element for kettle filtering, coffee machine filtering, and desktop water filters are paper type filters, which have low strength during use, are easy to deform, and the internal filter material thereof may leak easily, moreover, side leakage is easy to occur after installation, resulting in poor filtering efficiency, and the filter element may need to be replaced frequently.

### SUMMARY

In order to address the problem that the existing filter element for kettle filtering, coffee machine filtering, and desktop water filters are paper type filters, which have low strength during use, are easy to deform, and the internal filter material thereof may leak easily, moreover, side leakage is easy to occur after installation, resulting in poor filtering efficiency, and the filter element may need to be replaced frequently; the object of the present invention is to provide a filter element that prevents side leakage and is environmentally-friendly.

A side-leakage-proof and environmentally-friendly filter element of the present invention includes a water-entry netting, an inner side-leakage-proof layer, a skeleton supporting layer, a first filter material, and a second filter material; an inner side-leakage-proof layer is fixedly installed on an inner side wall of the skeleton supporting layer, an upper end of the inner side-leakage-proof layer is provided with a water-entry netting, the water-entry netting is fixedly installed at an upper end of the skeleton supporting layer, an inner upper side of the inner side-leakage-proof layer is filled with the first filter material, an inner lower side of the inner side-leakage-proof layer are filled with the second filter material, the bottom middle part of the inner side-leakage-proof layer is provided with a water outlet slot.

Preferably, a concave limiting groove is provided at an inner edge of the water-entry netting.

Preferably, the inner side-leakage-proof layer is one or a combination of a waterproof coating, a PP film, a PES film, a PE film, and a PVTF film.

Preferably, the skeleton supporting layer is a skeleton formed of a PET easily degradable material.

Preferably, the first filter material is one or a mixture of activated carbon and KDF filter material.

Preferably, the second filter material is one or a mixture of resin and heavy metal free filter material.

Compared with the prior art, the beneficial effects of the present invention are that:

(1) the present invention can prevent side leakage of water along the outer wall side before filtering, improve the use efficiency of filter material and have high stability;

(2) the present invention has high strength, is not easy to deform, at the same time realizes energy saving and environmental protection, and the service life thereof can be prolonged.

### BRIEF DESCRIPTION OF THE DRAWINGS

For ease of explanation, the present invention is described in detail by the following specific embodiments and drawings.

FIG. 1 is a schematic structural diagram of the present invention.

wherein: 1. water-entry netting; 2. inner side-leakage-proof layer; 3. skeleton supporting layer; 4. first filter material; 5. second filter material; 2-1. water outlet slot.

### DETAILED DESCRIPTION

To make the objectives, technical solutions, and advantages of the present invention clearer, the following describes the present invention through specific embodiments shown in the accompanying drawings.

It should be understood, however, that these descriptions are merely exemplary and are not intended to limit the scope of the invention. In addition, in the following description, descriptions of well-known structures and techniques are omitted to avoid unnecessarily obscuring the concept of the present invention.

It is also necessary to explain that in order to avoid obscuring the present invention due to unnecessary details, in the drawings, only structures and/or processing steps that are closely related to the solution according to the present invention are shown, and other details that have little to do with the present invention are omitted.

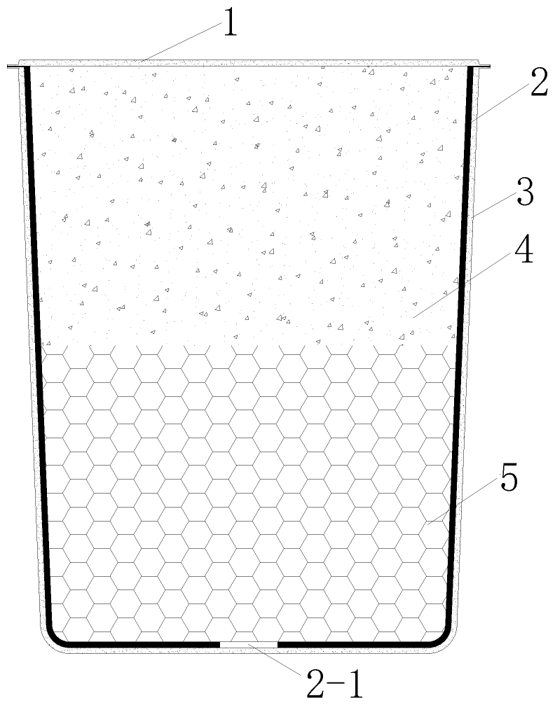

As shown in FIG. 1, this specific embodiment adopts the following technical solutions: including a water-entry netting 1, an inner side-leakage-proof layer 2, a skeleton supporting layer 3, a first filter material 4, a second filter material 5; the inner side-leakage-proof layer 2 is fixedly installed on an inner side wall of the skeleton supporting layer 3, an upper end of the inner side-leakage-proof layer is provided with the water-entry netting 1, the water-entry netting 1 is fixedly installed at an upper end of the skeleton supporting layer 3, an inner upper side of the inner side-leakage-proof layer is filled with the first filter material 4, an inner lower side of the inner side-leakage-proof layer are filled with the second filter material 5, the bottom middle part of the inner side-leakage-proof layer 2 is provided with a water outlet slot 2-1.

Further, a concave limiting groove is provided at an inner edge of the water-entry netting 1.

Further, the inner side-leakage-proof layer 2 is one or a combination of a waterproof coating, a PP film, a PES film, a PE film, and a PVTF film.

Further, the skeleton supporting layer 3 is a skeleton formed of a PET easily degradable material.

Further, the first filter material 4 is one or a mixture of activated carbon and KDF filter material.

Further, the second filter material 5 is one or a mixture of resin and heavy metal free filter material.

The working principle of this specific implementation mode is: the skeleton supporting layer 3 is used to realize the support, which can prevent the overall deformation, at the same time, the inner layer side-leakage-proof layer 2 can prevent side leakage and improve the filtering efficiency, and the water-entry netting 1 can prevent the filter material from leaking out, the first filter material and the second filter material can achieve water filtration and improve filtration efficiency; the overall strength is high, and it can be recycled, results in saving energy and protecting the environment.

It is obvious to those skilled in the art that the present invention is not limited to the details of the above-mentioned exemplary embodiments, and the present invention can be implemented in other specific forms without departing from the spirit or basic features of the present invention. Therefore, the embodiments should be considered as exemplary and non-limiting in every respect, the scope of the present invention is defined by the claims, rather than the foregoing description, and it is therefore intended to cover within the invention all changes that fall within the meaning and scope of equivalents of the claims.

In addition, it should be understood that although this specification is described in terms of embodiments, not every embodiment includes only an independent technical solution. This description of the specification is for clarity only, and those skilled in the art should take the specification as a whole. The technical solutions in the embodiments can also be appropriately combined to form other implementations that can be understood by those skilled in the art.

1. A side-leakage-proof and environmentally-friendly filter element, comprising a water-entry netting,
an inner side-leakage-proof layer,
a skeleton supporting layer,
a first filter material,
and a second filter material;
wherein the inner side-leakage-proof layer is fixedly installed on an inner side wall of the skeleton supporting layer, an upper end of the inner side-leakage-proof layer is provided with the water-entry netting, the water-entry netting is fixedly installed at an upper end of the skeleton supporting layer, an inner upper side of the inner side-leakage-proof layer is filled with the first filter material, an inner lower side of the inner side-leakage-proof layer are filled with the second filter material, the bottom middle part of the inner side-leakage-proof layer is provided with a water outlet slot.

2. The side-leakage-proof and environmentally-friendly filter element according to claim 1, wherein a concave limiting groove is provided at an inner edge of the water-entry netting.

3. The side-leakage-proof and environmentally-friendly filter element according to claim 1, wherein
the inner side-leakage-proof layer is one or a combination of a waterproof coating, a PA film, a PET film, a PP film, a PES film, a PE film, and a PTFE film.

4. The side-leakage-proof and environmentally-friendly filter element according to claim 1, wherein
the skeleton supporting layer is a skeleton formed of a PET easily degradable material.

5. The side-leakage-proof and environmentally-friendly filter element according to claim 1, wherein
the first filter material is one or a mixture of activated carbon and KDF filter material.

6. The side-leakage-proof and environmentally-friendly filter element according to claim 1, wherein
the second filter material is one or a mixture of resin and heavy metal free filter material.
